(19) United States
(12) Patent Application Publication
(10) Pub. No.: US 2011/0210638 A1
(43) Pub. Date: Sep. 1, 2011

(54) STATOR FOR ELECTRIC ROTATING MACHINE

(75) Inventors: Shinichi Ogawa, Obu-shi (JP); Atsuo Ishizuka, Nagoya (JP)

(73) Assignee: DENSO CORPORATION, Kariya-city (JP)

(21) Appl. No.: 13/035,108

(22) Filed: Feb. 25, 2011

(30) Foreign Application Priority Data
Feb. 26, 2010 (JP) 2010-042371

(51) Int. Cl. H02K 3/28

(52) U.S. Cl. 310/195

(57) ABSTRACT

A stator includes a stator coil comprised of electric wires each of which has in-slot portions received in slots of a stator core and turn portions located outside the slots to connect the in-slot portions. Each of the turn portions is stepped to have parallel parts that extend substantially parallel to a corresponding axial end face of the stator core. For each pair of the turn portions of the electric wires, which respectively protrude out of an adjacent pair of the slots of the stator core, the parallel parts of one of the turn portions overlap those of the other in the axial direction of the stator core. A clearance provided between one of the overlapping pairs of the parallel parts, which is positioned furthest from the corresponding axial end face of the stator core, is largest among all clearances provided between the overlapping pairs of the parallel parts.

### CROSS-REFERENCE TO RELATED APPLICATION

This application is based on and claims priority from Japanese Patent Application No, 2010-42371, filed on Feb. 26, 2010, the content of which is hereby incorporated by reference in its entirety into this application.

### BACKGROUND

1. Technical Field

The present invention relates to stators for electric rotating machines that are used in, for example, motor vehicles as electric motors and electric generators.

2. Description of the Related Art

Conventionally, there are known stators for electric rotating machines which include a hollow cylindrical stator core and a stator coil mounted on the stator core.

The stator core has a plurality of slots that are formed in the radially inner surface of the stator core and spaced in the circumferential direction of the stator core. The stator coil is comprised of a plurality of electric wires mounted on the stator core. Each of the electric wires includes a plurality of in-slot portions, each of which is received in a corresponding one of the slots of the stator core, and a plurality of turn portions each of which connects one adjacent pair of the in-slot portions of the electric wire and is located outside the slots of the stator core.

Moreover, Japanese Patent Application Publication No. 2009-268156 discloses a technique of reducing the protruding height of the turn portions of the electric wires from corresponding axial end faces of the stator core.

Specifically, according to the technique, as shown in FIG. 9, each of the turn portions 44, which connects one adjacent pair of the in-slot portions 43 of the electric wire 40, is stepped to have a plurality of parallel parts 46 that extend substantially parallel to the corresponding axial end face 30a of the stator core 30.

With the above configuration of the turn portions 44, it is possible to reduce the protruding height h of the turn portions 44 from the corresponding axial end faces 30a of the stator core 30 in the axial direction of the stator core 30. In other words, it is possible to reduce the height h of coil ends of the stator coil 4; each of the coil ends is comprised of all of those turn portions 44 of the electric wires 40 which protrude from the same axial end face 30a of the stator core 30.

However, with the above configuration, for each pair of the turn portions 44 of the electric wires 40, which respectively protrude out of an adjacent pair of the slots of the stator core 30, the parallel parts 46 of one of the turn portions 44 overlap corresponding ones of the parallel parts 46 of the other turn portion 44 in the axial direction of the stator core 30. Consequently, if the turn portions 44 of the electric wires 40 are caused to vibrate during operation of the electric rotating machine, the overlapping parallel parts 46 of the turn portions 44 may collide with or rub against each other, thereby damaging insulating coats provided at the outer surfaces thereof. As a result, it may become difficult to prevent insulation failure from occurring in the stator.

### SUMMARY

According to an embodiment, there is provided a stator for an electric rotating machine. The stator includes a hollow cylindrical stator core and a stator coil. The stator core has a plurality of slots and a pair of axial end faces. The slots are formed in the radially inner surface of the stator core and spaced in the circumferential direction of the stator core. The axial end faces are opposite to each other in the axial direction of the stator core. The stator coil is comprised of a plurality of electric wires mounted on the stator core. Each of the electric wires has a plurality of in-slot portions, each of which is received in a corresponding one of the slots of the stator core, and a plurality of turn portions each of which connects one adjacent pair of the in-slot portions of the electric wire and is located outside the slots of the stator core. Further, each of the turn portions of the electric wires is stepped to have a plurality of parallel parts that extend substantially parallel to a corresponding one of the axial end faces of the stator core. For each pair of the turn portions of the electric wires, which respectively protrude out of an adjacent pair of the slots of the stator core, the parallel parts of one of the turn portions overlap corresponding ones of the parallel parts of the other turn portion in the axial direction of the stator core. Between each overlapping pair of the parallel parts of the turn portions, there is provided a clearance for keeping them apart from each other. The clearance between one of the overlapping pairs of the parallel parts, which is positioned furthest from the corresponding axial end face of the stator core among all the overlapping pairs of the parallel parts, is largest among all the clearances between the overlapping pairs of the parallel parts.

With the clearances provided between the overlapping pairs of the parallel parts of the turn portions, it is possible to prevent the turn portions from making contact with each other even if they are caused to vibrate during operation of the electric rotating machine. As a result, it is possible to prevent insulating coats of the turn portions from being damaged due to vibration of the turn portions, thereby ensuring electric insulation between the turn portions.

Moreover, in general, if the turn portions of the electric wires are caused to vibrate during operation of the electric rotating machine, the amplitude of the vibration will increase with the distance from the stator core. However, by providing the largest clearance between the overlapping pair of the parallel parts which is positioned furthest from the corresponding axial end face of the stator core, it is still possible to reliably prevent the pair of the parallel parts from making contact with each other due to the vibration of the turn portions.

It is preferable that the clearances between the overlapping pairs of the parallel parts of the turn portions increase with the distances of the overlapping pairs from the corresponding axial end faces of the stator core.

The largest clearance is preferably set to be greater than or equal to twice the clearance between one of the overlapping pairs of the parallel parts which is positioned closest to the corresponding axial end face of the stator core among all the overlapping pairs of the parallel parts.

Preferably, for each of the turn portions of the electric wires, the heights of the parallel parts of the turn portion from the corresponding axial end face of the stator core increase with the distances of the parallel parts from the corresponding in-slot portions connected by the turn portion.

Each of the turn portions of the electric wires may further have a plurality of oblique parts each of which extends obliquely with respect to the corresponding axial end face of the stator core so as to connect one adjacent pair of the parallel parts of the turn portion. In this case, an acute angle between one of the oblique parts, which is positioned furthest from the corresponding axial end face of the stator core among all the oblique parts, and the corresponding axial end face of the stator coil is preferably set to be smallest among all acute angles between the oblique parts and the corresponding axial end face of the stator core.

It is further preferable that the acute angles between the oblique parts and the corresponding axial end face of the stator core decrease with increase in the distances of the oblique parts from the corresponding axial end face of the stator core.

### BRIEF DESCRIPTION OF THE DRAWINGS

The present invention will be understood more fully from the detailed description given hereinafter and from the accompanying drawings of one preferred embodiment of the invention, which, however, should not be taken to limit the invention to the specific embodiment but are for the purpose of explanation and understanding only.

In the accompanying drawings:

FIG. 1 is a schematic cross-sectional view illustrating the overall configuration of an electric rotating machine which includes a stator according to an embodiment of the invention;

FIG. 2 is an axial end view of the stator;

FIG. 3 is an axial end view of a stator core of the stator;

FIG. 4 is a plan view of one of stator core segments which make up the stator core;

FIG. 5A is a cross-sectional view illustrating the configuration of electric wires forming a stator coil of the stator;

FIG. 5B is a cross-sectional view illustrating a modification of the configuration of the electric wires shown in FIG. 5A;

FIG. 6 is a perspective view of the stator coil;

FIG. 7 is an enlarged perspective view showing part of one of the electric wires;

FIG. 8 is a schematic view illustrating the configuration of turn portions of the electric wires according to the embodiment; and

FIG. 9 is a schematic view illustrating the configuration of turn portions of electric wires forming a stator coil according to a related art.

### DESCRIPTION OF PREFERRED EMEODIMENT

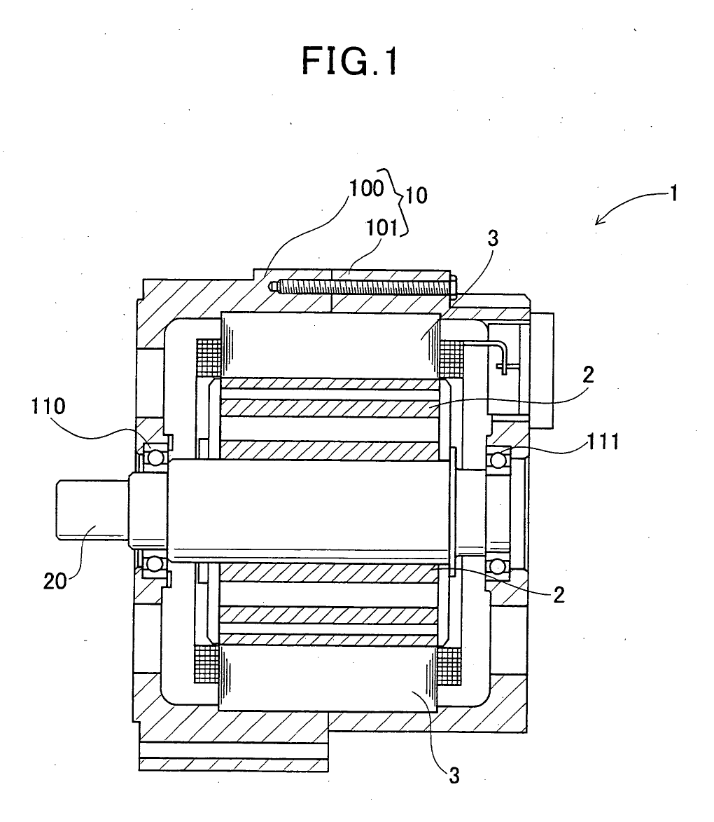

FIG. 1 shows the overall configuration of an electric rotating machine 1 which includes a stator 3 according to an embodiment of the invention.

The electric rotating machine 1 is designed for use in a motor vehicle, such as an electric vehicle or a hybrid vehicle, and can function both as an electric motor and as an electric generator.

As shown in FIG. 1, the electric rotating machine 1 further includes a housing 10 and a rotor 2 in addition to the stator 3. The housing 10 is comprised of a pair of cup-shaped housing pieces 100 and 101 which are jointed together at the open ends thereof. The housing 10 has a pair of bearings 110 and 111 mounted therein, via which a rotating shaft 20 is rotatably supported by the housing 10. The rotor 2 is received in the housing 10 and fixed on the rotating shaft 20. The stator 3 is fixed in the housing 10 so as to surround the radially outer periphery of the rotor 2.

The rotor 2 includes a plurality of permanent magnets that form a plurality of magnetic poles on the radially outer periphery of the rotor 2 to face the radially inner periphery of the stator 3. The polarities of the magnetic poles alternate between north and south in the circumferential direction of the rotor 2. The number of the magnetic poles is set according to the design specification of the electric rotating machine 1. In the present embodiment, the number of the magnetic poles is set to be equal to, for example, eight (i.e., four north poles and four south poles).

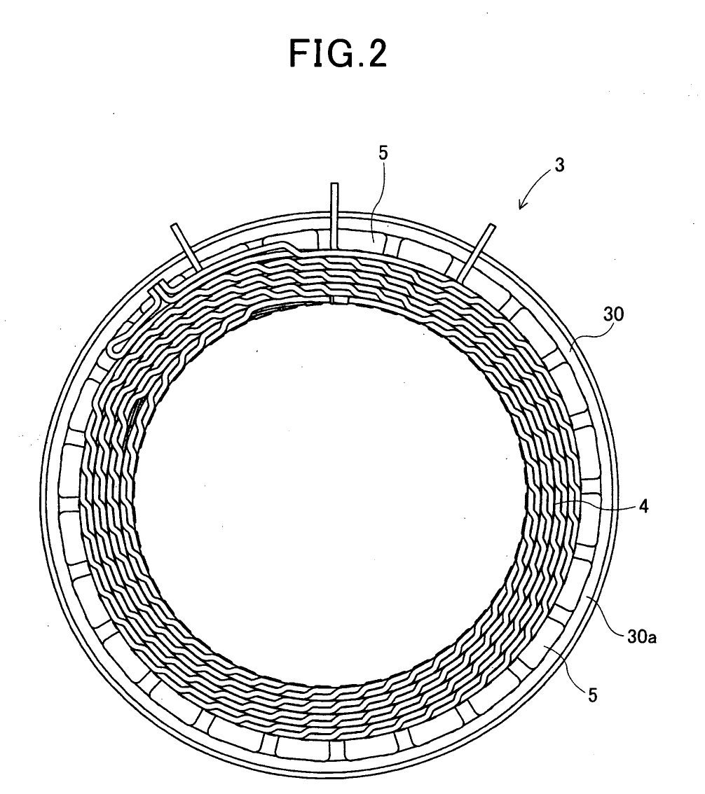

Referring now to FIG. 2, the stator 3 includes a hollow cylindrical stator core 30, a three-phase stator coil 4 mounted on the stator core 30, and insulating paper 5 interposed between the stator core 30 and the stator coil 4.

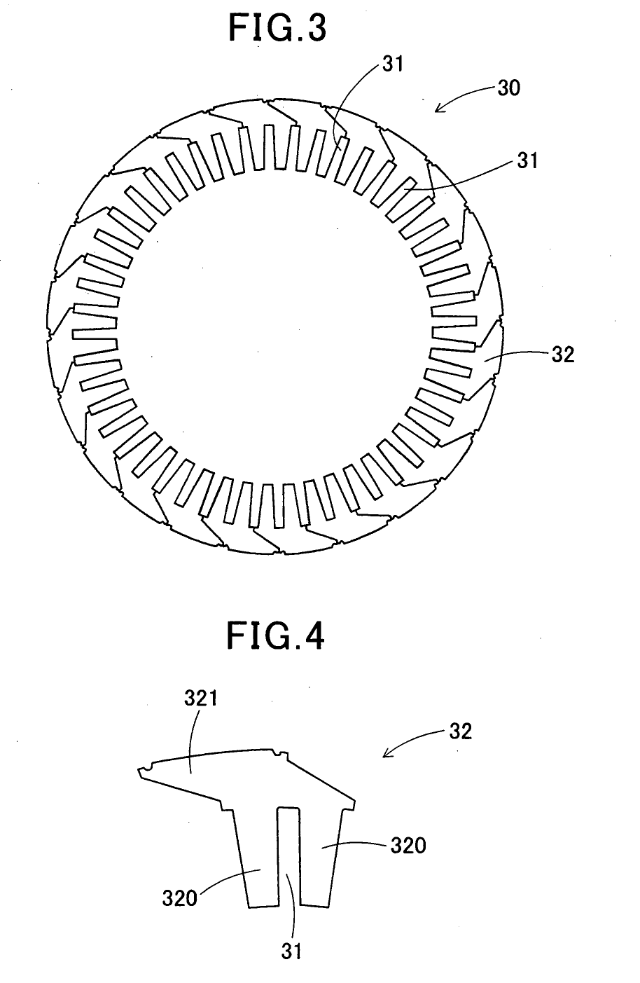

The stator core 30 has, as shown in FIG. 3, a plurality of slots 31 that are formed in the radially inner surface of the stator core 30 and spaced in the circumferential direction of the stator core 30 at predetermined intervals, For each of the slots 31, the depth-wise direction of the slot 31 is coincident with a radial direction of the stator core 30. In the present embodiment, there are provided two slots 31 per magnetic pole of the rotor 2 that has the eight magnetic poles and per phase of the three-phase stator coil 4. Accordingly, the total number of the slots 31 provided in the stator core 30 is equal to 48 (i.e., 2×8×3).

Moreover, in the present embodiment, the stator core 30 is comprised of, for example, 24 stator core segments 32 as shown in FIG. 4. The stator core segments 32 are arranged so as to adjoin one another in the circumferential direction of the stator core 30. Each of the stator core segments 32 defines therein one of the slots 31. Further, each circurnferentially-adjoining pair of the stator core segments 32 together defines a further one of the slots 31 therebetween. Each of the stator core segments 32 also has two tooth portions 320, which radially extend to form the one of the slots 31 therebetween, and a back core portion 321 that is located radially outward of the tooth portions 320 to connect them.

In the present embodiment, each of the stator core segments 32 is formed by laminating a plurality of magnetic steel sheets with insulating films interposed therebetween. It should be noted that other conventional metal sheets may also be used instead of the magnetic steel sheets.

The three-phase stator coil 4 is comprised of a plurality of wave-shaped electric wires 40 mounted on the stator core 30.

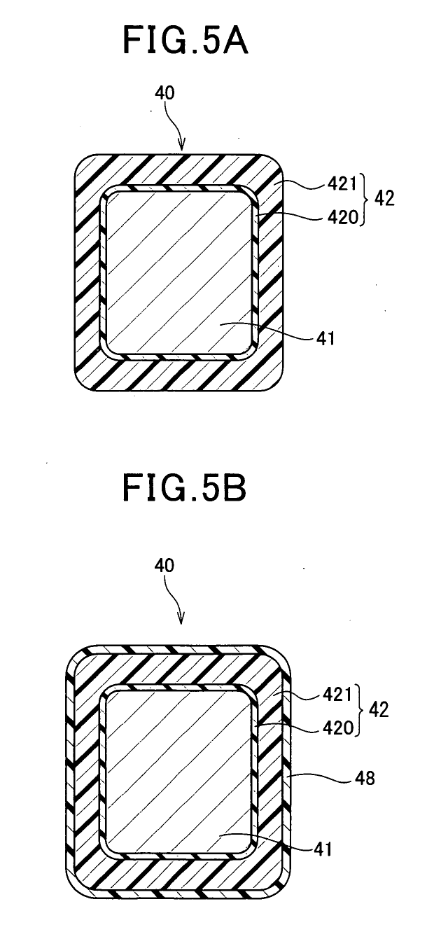

As shown in FIG. 5A, each of the electric wires 40 is configured with an electric conductor 41 and an insulating coat 42 that covers the outer surface of the electric conductor 41.

In the present embodiment, the electric conductor 41 is made of copper and has a substantially rectangular cross section. The insulating coat 42 is two-layer structured to include an inner layer 420 and an outer layer 421. The thickness of the insulating coat 42 (i.e., the sum of thicknesses of the inner and outer layers 420 and 421) is set to be in the range of 100 to 200 μm.

With such a large thickness of the two-layer structured insulating coat 42, it is possible to reliably insulate the electric wires 40 from one another without interposing insulating paper therebetween. However, it is also possible to interpose insulating paper between the electric wires 40 so as to further enhance the electrical insulation therebetween.

Further, the outer layer 421 is made of an insulating material such as nylon. The inner layer 420 is made of a thermoplastic resin having a higher glass transition temperature than the outer layer 421 or an insulating material having no glass transition temperature such as a polyamide-imide resin. Consequently, the outer layers 421 of the electric wires 40 will be solidified by the heat generated by operation of the electric rotating machine 1 earlier than the inner layers 420. As a result, the surface hardness of the outer layers 421 will be increased, thereby enhancing the electrical insulation between the electric wires 40.

Furthermore, as shown in FIG. 5B, it is also possible for each of the electric wires 40 to further include a fusible coat 48 to cover the outer surface of the insulating coat 42; the fusible coat 48 may be made, for example, of epoxy resin. In this case, the fusible coats 48 of the electric wires 40 will be fused by the heat generated by operation of the electric rotating machine I earlier than the insulating coats 42, thereby bonding together those portions of the electric wires 40 which are received in the same ones of the slots 31 of the stator core 30. As a result, those portions of the electric wires 40 will be integrated into a rigid body, thereby enhancing the mechanical strength thereof. In addition, the outer layers 421 of the insulating coats 42 of the electric wires 40 may also be made of PPS (polyphenylene sulfide).

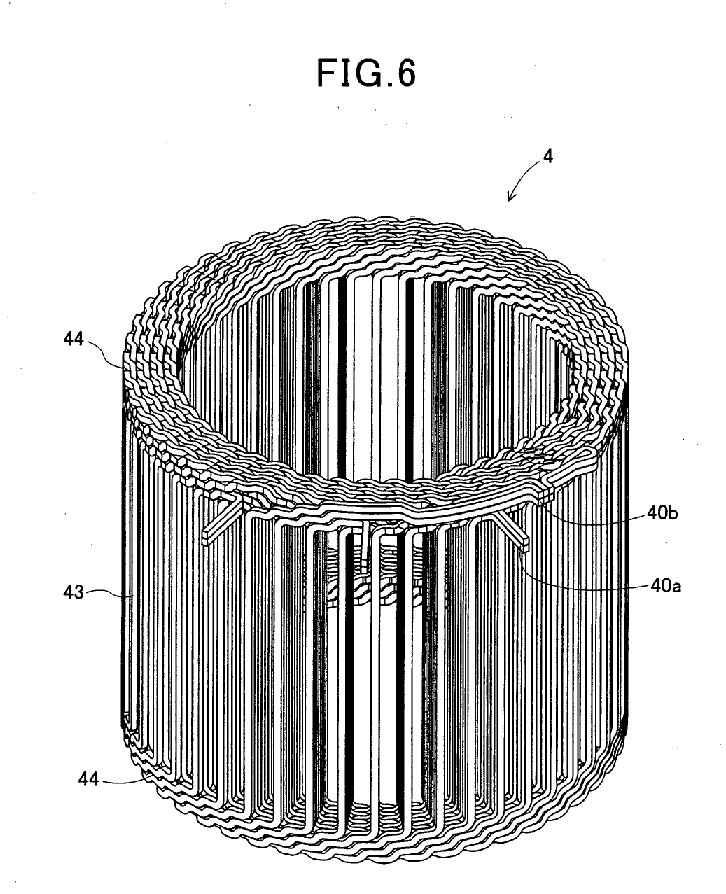

In the present embodiment, the stator coil 4 is produced by first interlacing the electric wires 40 to form a substantially planar band-shaped assembly (not shown) and then rolling the assembly into the hollow cylindrical shape as shown in FIG. 6. Moreover, each of the electric wires 40 is wave-shaped to include a plurality of in-slot portions 43 and a plurality of turn portions 44.

The in-slot portions 43 extend straight in parallel with each other and are equally spaced at predetermined intervals. After assembling the stator core 30 to the stator coil 4, each of the in-slot portions 43 is received in a corresponding one of the slots 31 of the stator core 30.

In addition, in the present embodiment, the slots 31 of the stator core 30 are divided into eight groups each of which includes six circumferentially-adjacent slots 31. For each of the electric wires 40, all the in-slot portions 43 of the electric wire 40 are received in eight slots 31 that belong respectively to the eight groups and are spaced six slots 31 apart in the circumferential direction of the stator core 30.

Each of the turn portions 44 extends to connect one adjacent pair of the in-slot portions 43. After assembling the stator core 30 to the stator coil 4, each of the turn portions 44 is located outside the slots 31 of the stator core 30.

Further, for each of the electric wires 40, each of the turn portions 44 of the electric wire 40 protrudes from a corresponding one of axial end faces 30a of the stator core 30 to connect the adjacent pair of the in-slot portions 43 of the electric wire 40. Consequently, all of those turn portions 44 of the electric wires 40 which protrude from the same axial end face 30a of the stator core 30 together make up a coil end of the stator coil 4. That is, the stator coil 4 includes two coil ends that respectively protrude from the axial end faces 30a of the stator core 30.

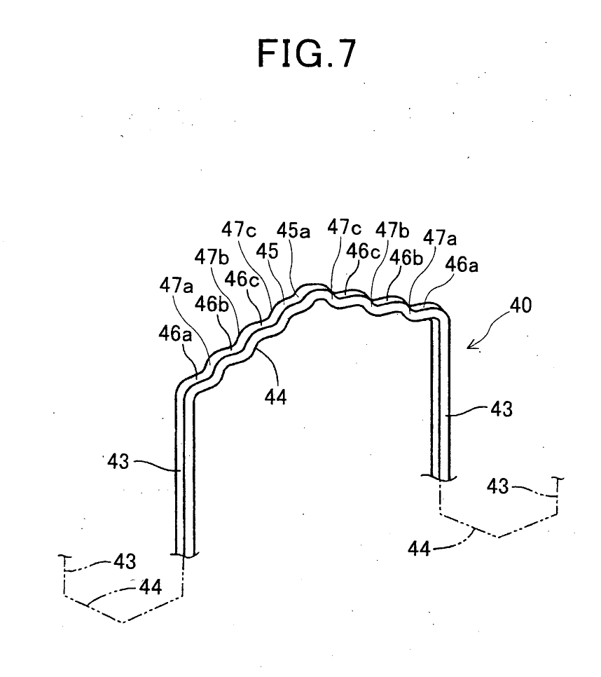

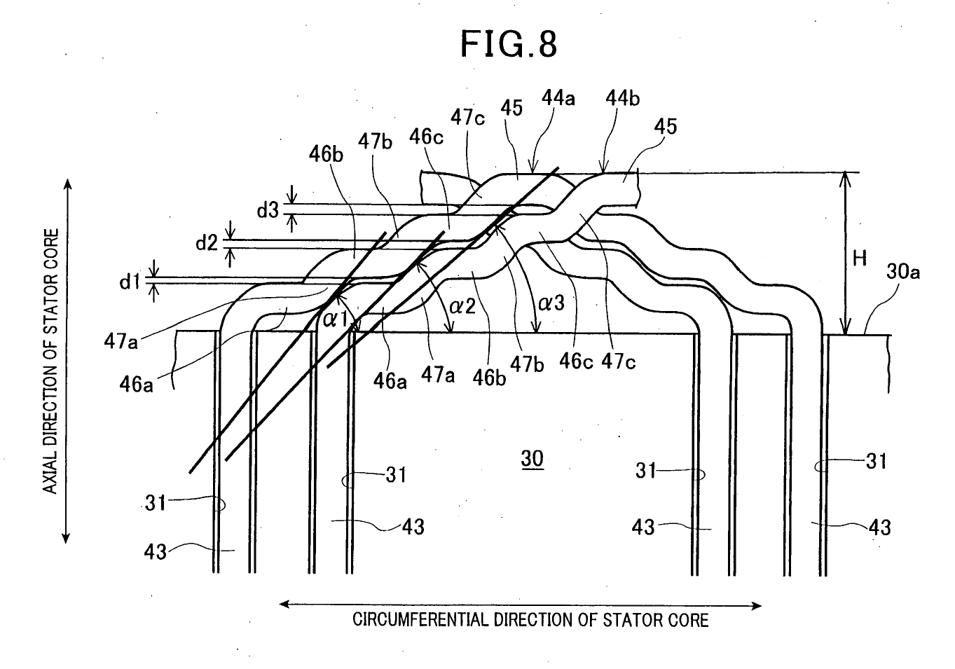

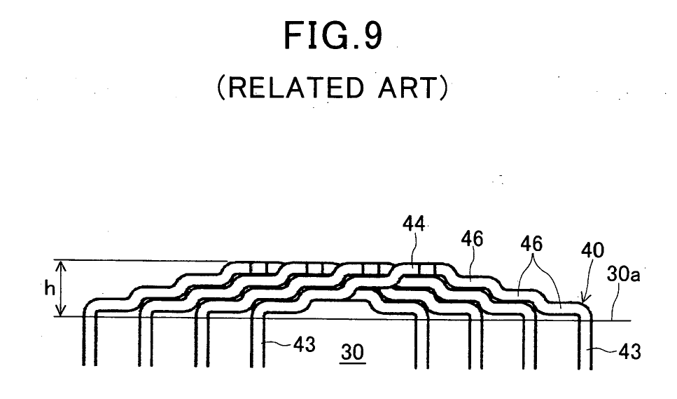

Referring to FIGS. 7 and 8, in the present embodiment, each of the turn portions 44 of the electric wires 40 is stepped to have a plurality of parallel parts 45 and 46a-46c that extend substantially parallel to the corresponding axial end face 30a of the stator core 30. Hereinafter, the expression “substantially parallel” means that the parallel parts 45 and 46a-46c are not necessarily exactly parallel to the corresponding axial end face 30a of the stator core 30, but have sufficient parallelism with respect to the axial end face 30a so as to allow a reduction in the protruding height of the turn portion 44 from the axial end face 30a.

More specifically, each of the turn portions 44 has one parallel part 45 that is centered in the turn portion 44 and positioned furthest from the corresponding axial end face 30a of the stator core 30. Each of the turn portions 44 also includes a crank-shaped part 45a that is formed substantially at the center of the parallel part 45 so as to offset the turn portion 44 in a radial direction of the stator core 30 (i.e., the direction perpendicular to the paper surface of FIG. 8). It should be noted that the term “crank-shaped” is used here only for the purpose of describing the overall shape of the part 45a and does not restrict the internal angles of the part 45a to 90°.

Further, in the present embodiment, the amount of radial offset made by each of the crank-shaped parts 45a formed in the turn portions 44 of the electric wires 40 is set to be 1.0-1.3 times the radial thickness of the in-slot portions 43 of the electric wires 40. Here, the amount of radial offset made by each of the crank-shaped parts 45a is defined as the difference in radial position between the opposite ends of the crank-shaped part 45a. Accordingly, for each of the electric wires 40, the difference in radial position between each adjacent pair of the in-slot portions 43, which are connected by a corresponding one of the turn portions 44, is equal to 1.0-1.3 times the radial thickness (i.e., thickness in the radial direction of the stator core 30) of the in-slot portions 43.

Setting the amount of radial offset as above, it is possible to densely arrange the turn portions 44 of the electric wires 40, thereby minimizing the size of the coil ends of the stator coil 4. In addition, it is also possible to make each adjacent pair of the turn portions 44 of the electric wires 40 extend in the circumferential direction of the stator core 30 without interference therebetween.

Moreover, each of the turn portions 44 of the electric wires 40 is symmetrical with respect to the parallel part 45 thereof. Each of the turn portions 44 of the electric wires 40 further has, on each of both sides of the parallel part 45, three parallel parts 46a-46c that are located at different distances from the corresponding axial end face 30a of the stator core 30. Accordingly, in the present embodiment, each of the turn portions 44 of the electric wires 40 has a total of seven parallel parts.

Furthermore, in the present embodiment, the length of each of the parallel parts 45 and 46a-46c in the circumferential direction of the stator core 30 is set to be less than the distance between each circumferentially-adjacent pair of the slots 31 of the stator core 30.

Setting the length as above, it is possible to prevent interference between each pair of the turn portions 44 of the electric wires 40 which respectively protrude out of one circumferentially-adjacent pair of the slots 31 of the stator core 30. Consequently, it is possible to prevent both the axial height and radial thickness of the coil ends of the stator coil 4 from being increased for preventing the above-described interference.

Moreover, in the present embodiment, for each of the turn portions 44 of the electric wires 40, the heights H of the parallel parts 45 and 46a-46c from the corresponding axial end face 30a of the stator core 30 are so set as to increase with the distances of the parallel parts from the corresponding in-slot portions 51 connected by the turn portion 44. In other words, the further the parallel parts are distant from the corresponding in-slot portions 51, the greater the heights H of the parallel parts are. Hereinafter, for each of the parallel parts 45 and 46a-46c, the height H represents the distance from the corresponding axial end face 30a of the stator core 30 to the axially outer surface of the parallel part. In the present embodiment, each of the turn portions 44 of the electric wires 40 further has a plurality of oblique parts 47a-47c that extend obliquely with respect to the corresponding axial end face 30a of the stator core 30 so as to connect adjacent pairs of the parallel parts 45 and 46a-46c of the turn portion 44.

More specifically, each of the turn portions 44 of the electric wires 40 includes: two oblique parts 47a each of which extends obliquely with respect to the corresponding axial end face 30a of the stator core 30 to connect one adjacent pair of the parallel parts 46a and 46b; two oblique parts 47b each of which extends obliquely to connect one adjacent pair of the parallel parts 46b and 46c; and two oblique parts 47c each of which extends obliquely to connect one adjacent pair of the parallel parts 46c and 45.

As described above, in the present embodiment, each of the turn portions 44 of the electric wires 40 is stepped to have the plurality of parallel parts 45 and 46a-46c. Consequently, as shown in FIG. 8, for each pair of the turn portions 44 of the electric wires 40, which respectively protrude out of an adjacent pair of the slots 31 of the stator core 30, the parallel parts of one of the turn portions 44 overlap corresponding ones of the parallel parts of the other turn portion 44 in the axial direction of the stator core 30. Further, between each overlapping pair of the parallel parts of the turn portions 44, there is provided a clearance for keeping them apart from each other.

More specifically, taking a pair of the turn portions 44a and 44b as an example, the parallel part 46b of the turn portion 44a overlaps the parallel part 46a of the turn portion 44b in the axial direction of the stator core 30 with a clearance dl provided therebetween. The parallel part 46c of the turn portion 44a overlaps the parallel part 46b of the turn portion 44b in the axial direction with a clearance d2 provided therebetween, The parallel part 45 of the turn portion 44a overlaps the parallel part 46c of the turn portion 44b in the axial direction with a clearance d3 provided therebetween.

Further, in the present embodiment, the clearances d1-d3 between the overlapping pairs of the parallel parts of the turn portions 44 of the electric wires 40 are so set as to increase with the distances of the overlapping pairs from the corresponding axial end faces 30a of the stator core 30. That is, d1<d2<d3. In other words, the further the overlapping pairs of the parallel parts are distant from the corresponding axial end faces 30a of the stator core 30, the greater the clearances between the overlapping pairs of the parallel parts are.

Moreover, in the present embodiment, the maximum clearance d3 is set to be greater than or equal to twice the minimum clearance dl. That is, d3≧2d1.

More specificially, in. the present embodiment, the clearance d1 is set to be about 0.3 mm. The clearance d2 is set to be about 0.45 mm. The clearance d3 is set to be about 0.65 mm.

Furthermore, in the present embodiment, for each of the turn portions 44 of the electric wires 40, the acute angles between the oblique parts 47a-47c of the turn portion 44 and the corresponding axial end face 30a of the stator core 30 are so set as to decrease with increase in the distances of the oblique parts 47a-47c from the corresponding axial end face 30a. That is, a1>a2>a3, where al represents the acute angle between each of the oblique parts 47a and the corresponding axial end face 30a of the stator core 30, a2 represents the acute angle between each of the oblique parts 47b and the corresponding axial end face 30a, and a3 represents the acute angle between each of the oblique parts 47c and the corresponding axial end face 30a. In other words, the further the oblique parts are distant from the corresponding axial end face 30a of the stator core 30, the smaller the acute angles between the oblique parts and the corresponding axial end face 30a are.

The above-described stator 3 according to the present embodiment has the following advantages.

In the present embodiment, for each pair of the turn portions 44 of the electric wires 40, which respectively protrude out of an adjacent pair of the slots 31 of the stator core 30, the parallel parts of one of the turn portions 44 overlap corresponding ones of the parallel parts of the other turn portion 44 in the axial direction of the stator core 30. Further, between each overlapping pair of the parallel parts of the turn portions 44, there is provided the clearance for keeping them apart from each other.

Consequently, with the clearances d1-d3 provided between the overlapping pairs of the parallel parts 45 and 46a-46c of the turn portions 44, it is possible to prevent the turn portions 44 from making contact with each other even if they are caused to vibrate during operation of the electric rotating machine 1. As a result, it is possible to prevent the insulating coats 42 of the turn portions 44 from being damaged due to vibration of the turn portions 44, thereby ensuring electric insulation between the turn portions 44,

Further, in the present embodiment, the clearance d3 between each overlapping pair of one of the parallel parts 45 and one of the parallel pasts 46c of the turn portions 44 is set to be largest among all the clearances d1-d3 between the overlapping pairs of the parallel parts of the turn portions 44. The overlapping pairs of the parallel parts 45 and 46c of the turn portions 44 are positioned furthest from the corresponding axial end faces 30a of the stator core 30 among all the overlapping pairs of the parallel parts of the turn portions 44.

In general, if the turn portions 44 of the electric wires 40 are caused to vibrate during operation of the electric rotating machine 1, the amplitude of the vibration will increase with the distance from the stator core 30. Accordingly, the amplitude of the vibration at the overlapping pairs of the parallel parts 45 and 46c of the turn portions 44 will be greater than those at the other overlapping pairs of the parallel parts of the turn portions 44. However, by providing the maximum clearance d3 between the overlapping pairs of the parallel parts 45 and 46c of the turn portions 44, it is still possible to reliably prevent the parallel parts 45 from making contact with the parallel parts 46c due to the vibration of the turn portions 44. As a result, it is possible to reliably prevent the insulating coats 42 of the turn portions 44 from being damaged due to the vibration of the turn portions 44, thereby reliably ensuring electric insulation between the turn portions 44.

In the present embodiment, the clearances d1-d3 between the overlapping pairs of the parallel parts 45 and 46a-46c of the turn portions 44 are so set as to increase with the distances of the overlapping pairs from the corresponding axial end faces 30a of the stator core 30. That is, the clearances d1-d3 are so set that d1<d2<d3.

As described above, if the turn portions 44 of the electric wires 40 are caused to vibrate during operation of the electric rotating machine 1, the amplitude of the vibration will increase with, the distance from the stator core 30. However, by setting the clearances d1-d3 as above, it is possible to reliably prevent the parallel parts 45 and 46a-46c of the turn portions 44 from making contact with each other due to the vibration of the turn portions 44. As a result, it is possible to more reliably prevent the insulating coats 42 of the turn portions 44 from being damaged due to the vibration of the turn portions 44, thereby more reliably ensuring electric insulation between the turn portions 44.

In the present embodiment, the maximum clearance d3 is set to be greater than or equal to twice the minimum clearance d1.

As described above, if the turn portions 44 of the electric wires 40 are caused to vibrate during operation of the electric rotating machine 1, the amplitude of the vibration at the overlapping pairs of the parallel parts 45 and 46c of the turn portions 44 will be greater than those at the other overlapping pairs of the parallel parts of the turn portions 44. However, by setting the maximum clearance d3 as above, it is possible to more reliably prevent the parallel parts 45 from making contact with the parallel parts 46c due to the vibration of the turn portions 44. As a result, it is possible to more reliably prevent the insulating coats 42 of the turn portions 44 from being damaged due to the vibration of the turn portions 44, thereby more reliably ensuring electric insulation between the turn portions 44.

In the present embodiment, for each of the turn portions 44 of the electric wires 40, the heights H of the parallel parts 45 and 46a-46c of the turn portion 44 from the corresponding axial end face 30a of the stator core 30 increase with the distances of the parallel parts from the corresponding in-slot portions SI connected by the turn portion 44.

With the above configuration, each of the turn portions 44 of the electric wires 40 maximally protrudes at the center thereof from the corresponding axial end face 30a of the stator core 30. Consequently, it is possible to configure each of the turn portions 44 to have a symmetrically stepped shape as shown in FIGS. 7 and 8.

In the present embodiment, each of the turn portions 44 of the electric wires 40 further has the oblique parts 47a-47c that extend obliquely with respect to the corresponding axial end face 30a of the stator core 30 so as to connect adjacent pairs of the parallel parts 45 and 46a-46c of the turn portion 44. Moreover, the acute angle a3 between each of the oblique parts 47c and the corresponding axial end face 30a of the stator core 30 is set to be smallest among all the acute angles a1-a3 between the oblique parts 47a-47c and the corresponding axial end face 30a. The oblique parts 47c are positioned furthest from the corresponding axial end face 30a of the stator core 30 among all the oblique parts 47a-47c.

Setting the acute angle a3 as above, it is possible to easily set the clearance d3 to be largest among all the clearances d1-d3.

Further, in the present embodiment, the acute angles a1-a3 between the oblique parts 47a-47c and the corresponding axial end face 30a of the stator core 30 are so set as to decrease with increase in the distances of the oblique parts 47a-47c from the corresponding axial end face 30a. That is, the acute angles a1-a3 are so set that a1>a2>a3.

Setting the acute angles a1-a3 as above, it is possible to easily set the clearances d1-d3 such that d1<d2<d3.

While the above particular embodiment of the invention has been shown and described, it will be understood by those skilled in the art that various modifications, changes, and improvements may be made without departing from the spirit of the invention.

For example, in the previous embodiment, each of the turn portions 44 of the electric wires 40 is stepped in four stages to have a total of seven parallel parts 45 and 46a-46c. However, each of the turn portions 44 may also be stepped in a different number of stages to have a different number of parallel parts.

In the previous embodiment, each of the turn portions 44 of the electric wires 40 is configured to be symmetrical with respect to the parallel part 45 thereof. However, each of the turn portions 44 may also be configured to be asymmetrical with respect to the parallel part 45.

In the previous embodiment, the stator coil 4 is produced by first interlacing the electric wires 40 to form a substantially planar band-shaped assembly and then rolling the assembly into the hollow cylindrical shape as shown in FIG. 6. However, the stator coil 4 may also be produced by, for example, first stacking the electric wires 40 without interlacing them to form a substantially planar band-shaped assembly and then rolling the assembly into a hollow cylindrical shape.

In the previous embodiment, each of the electric wires 40 has, as shown in FIG. 6, both ends 40a and 40b thereof located on the radially outer periphery of the stator coil 4. However, it is also possible to locate the ends 40a and 40b of each of the electric wires 40 respectively on the inner and outer peripheries of the stator coil 4.

What is claimed is:

1. A stator for an electric rotating machine, the stator comprising:
a hollow cylindrical stator core having a plurality of slots and a pair of axial end faces, the slots being formed in a radially inner surface of the stator core and spaced in a circumferential direction of the stator core, the axial end faces being opposite to each other in an axial direction of the stator core; and
a stator coil comprised of a plurality of electric wires mounted on the stator core, each of the electric wires having a plurality of in-slot portions, each of which is received in a corresponding one of the slots of the stator core, and a plurality of turn portions each of which connects one adjacent pair of the in-slot portions of the electric wire and is located outside the slots of the stator core,
wherein
each of the turn portions of the electric wires is stepped to have a plurality of parallel parts that extend substantially parallel to a corresponding one of the axial end faces of the stator core,
for each pair of the turn portions of the electric wires, which respectively protrude out of an adjacent pair of the slots of the stator core, the parallel parts of one of the turn portions overlap corresponding ones of the parallel parts of the other turn portion in the axial direction of the stator core,
between each overlapping pair of the parallel parts of the turn portions, there is provided a clearance for keeping them apart from each other, and
the clearance between one of the overlapping pairs of the parallel parts, which is positioned furthest from the corresponding axial end face of the stator core among all the overlapping pairs of the parallel parts, is largest among all the clearances between the overlapping pairs of the parallel parts.

2. The stator as set forth in claim 1, wherein the clearances between the overlapping pairs of the parallel parts of the turn portions increase with the distances of the overlapping pairs from the corresponding axial end faces of the stator core.

3. The stator as set forth in claim 1, wherein the largest clearance is greater than or equal to twice the clearance between one of the overlapping pairs of the parallel parts which is positioned closest to the corresponding axial end face of the stator core among all the overlapping pairs of the parallel parts.

4. The stator as set forth in claim 1, wherein for each of the turn portions of the electric wires, the heights of the parallel parts of the turn portion from the corresponding axial end face of the stator core increase with the distances of the parallel parts from the corresponding in-slot portions connected by the turn portion.

5. The stator as set forth in claim 1, wherein each of the turn portions of the electric wires further has a plurality of oblique parts each of which extends obliquely with respect to the corresponding axial end face of the stator core so as to connect one adjacent pair of the parallel parts of the turn portion, and
an acute angle between one of the oblique parts, which is positioned furthest from the corresponding axial end face of the stator core among all the oblique parts, and the corresponding axial end face of the stator core is smallest among all acute angles between the oblique parts and the corresponding axial end face of the stator core.

6. The stator as set forth in claim 5, wherein the acute angles between the oblique parts and the corresponding axial end face of the stator core decrease with increase in the distances of the oblique parts from the corresponding axial end face of the stator core.
